(19) United States
(12) Patent Application Publication
(10) Pub. No.: US 2026/0254061 A1
(43) Pub. Date: Aug. 27, 2026

(54) Method for Producing an Electrode, Electrode, and Stored Energy Source Comprising the Electrode

(71) Applicant: Bayerische Motoren Werke Aktiengesellschaft, Muenchen (DE)

(72) Inventors: Hyunchul ROH, Muenchen (DE); Nina ZENSEN, Pfaffenhofen an der Ilm (DE)

(21) Appl. No.: 19/489,633

(22) PCT Filed: May 28, 2024
(86) PCT No.: PCT/DE2024/100490

§ 371 Date: Dec. 3, 2025

(30) Foreign Application Priority Data
Jun. 21, 2023 (DE) 10 2023 116 293.4

(51) Int. Cl. H01M 50/536; H01M 4/139; H01M 50/533; H01M 50/534

(52) U.S. Cl. CPC H01M 50/536; H01M 4/139; H01M 50/533; H01M 50/534

(57) ABSTRACT

A method for producing an electrode for a stored energy source includes: A) providing a first electrode film which is self-supporting and electrically conductive and a second electrode film which is self-supporting and electrically conductive; B) providing at least one current conductor tab, wherein the current conductor tab is electrically connected to movable wires; and C) arranging the movable wires of the current conductor tab between the first and the second electrode films and connecting the first electrode film to the second electrode film to form a self-supporting electrode layer, wherein the electrode is formed and wherein the current conductor tag protrudes from the electrode layer and the movable wires extend in the electrode layer. Such a method is particularly suitable for producing electrodes in which no mechanical stresses occur between a current collector and the electrode layer.

### BACKGROUND AND SUMMARY

The present invention relates to a method for producing an electrode for a stored energy source, the electrode, and a stored energy source comprising the electrode.

In the production of electrodes for stored energy sources, for example, lithium-ion batteries or solid-state batteries, electrode materials are often applied to current collector films in a wet-chemical process using squeegee blades, or with the aid of slot dies, and dried to form an electrode layer. The drying is often very time-consuming, wherein flaws in the electrode composite layer, such as air inclusions, can also occur during the wet-chemical application. Furthermore, a lack of adhesion of the electrode layer to the current collector film is also a problem.

Producing dry electrode layers as electrode films, which can be applied by way of calendering to a current collector film or a current collector mesh, is also known. The current collector film can be deformed during the calendering, so that internal mechanical tensions build up between the electrode film and the current collector film. To ensure sufficient adhesion of the electrode films to the current collector film, the current collector films often also have to be etched or pretreated using priming substances (primary substances) in a time-consuming and costly process. The current collector films, which generally consist of copper in the case of anode films and are often manufactured from aluminum in the case of cathode films, additionally increase the weight and the costs of the individual electrodes.

It is the object of the present disclosure to specify a method for producing an electrode which is improved with respect to the abovementioned disadvantages. In particular, it is an object of the present disclosure to specify a method for producing an electrode, in which the internal mechanical tension between the structures for discharging the current and the electrode material is reduced.

This object is achieved by a method for producing an electrode for a stored energy source. An electrode and a stored energy source are the subject matter of further independent claims.

One aspect of the disclosure provides a method for producing an electrode for a stored energy source. The method comprises the following method steps:
A) providing a first electrode film, which is self-supporting and electrically conductive, and a second electrode film, which is self-supporting and electrically conductive,
B) providing at least one current conductor tab, wherein the current conductor tab is electrically conductively connected to movable wires, and
C) arranging the movable wires of the current conductor tab between the first and second electrode film, and connecting the first electrode film to the second electrode film to form a self-supporting electrode layer, wherein the electrode is formed and wherein the current conductor tab protrudes out of the electrode layer and the movable wires extend into the electrode layer.

The method according to the disclosure permits easy connection of self-supporting electrode films to form an electrode layer, wherein movable wires are used as structures for conducting the electric current, which are electrically conductively connected to at least one current conductor tab. The movable wires can be arranged particularly easily between the first and the second electrode film, wherein due to the mobility of the wires, mechanical tensions can be avoided during the connection of the electrode films, which often occur with planar current collector films. The movable wires instead also adapt themselves particularly easily to possible irregularities of the electrode films, so that bulging, which can arise if there are mechanical tensions between a current collector and the electrode layer, is avoided. Furthermore, a first and a second electrode film are connected to one another in the method according to the disclosure, so that the problems typically occurring when connecting electrode films having metallic current collector films with respect to a lack of adhesion can be avoided. Possibly occurring tension between the current collector film and the electrode film, which can result in bending of the electrode similar to a saber shape, can thus also be reduced. In particular, etching of the electrical wires or pretreating the electrical wires using a primary substance is not necessary in the method according to the disclosure.

During the operation of the electrode, the current is discharged by the electrode material by way of the electrically conductive wires at the current conductor tab and conducted from there to the electric pole of the stored energy source connected to the current conductor tab. During the connection of the first and second electrode film, the movable wires are fixed in different positions in the electrode layer being formed and extend from the current conductor tab in a random manner within the electrode layer.

The wires extending in a random manner within the electrode layer can meander in various ways through the electrode layer, wherein generally different wires meander in different ways within the electrode layer.

The movable wires are furthermore also flexible and can be bent, for example, before the connection of the first electrode film and the second electrode film so that after the fixing in method step C) by the formation of the self-supporting electrode layer, they primarily extend away from the current conductor tab. Due to slight differences in the surface quality of the two electrode films, nonetheless the movable wires are fixed in different positions in the electrode layer being formed during method step C).

The first self-supporting electrode film and the second electrode film can comprise a binder, which can be used to connect both electrode films. The first and the second electrode film can be used and unrolled as a rolled product during method step A).

In a further embodiment of a method according to the disclosure, a plurality of current conductor tabs can be provided in method step B). Each current conductor tab is connected to movable wires. In method step C), the movable wires of the plurality of current conductor tabs are then arranged between the first and second electrode film, wherein the plurality of the current conductor tabs protrudes out of the electrode layer.

After the connection of the two electrode films, the wires of the plurality of current conductor tabs extend within the electrode layer. So-called “multi-tab” electrodes, which comprise a plurality of current conductor tabs, can be produced particularly easily using such a method. Such electrodes having a plurality of current conductor tabs can reduce the ohmic resistance of the electrode layer.

In method step C), an electrode layer which has a first edge and a second edge opposite to the first edge can be formed. The at least one current conductor tab or the plurality of current conductor tabs can protrude out of the electrode layer at the first edge. The wires fixed in the electrode layer, which are electrically conductively connected to the one or the plurality of current conductor tabs, can extend starting from the current conductor tabs in a random manner in the direction of the second edge within the electrode layer.

This can particularly easily ensure the current discharge through the electrode from the second edge in the direction of the current conductor tab located at the first edge or in the direction of the plurality of current conductor tabs.

The electrode formed by way of a method according to the disclosure can in particular form a long band, which comprises a band-shaped electrode layer. The long band is normally rolled up to form an electrode roll. The electrode roll can have a length of up to 1000 m, in particular a length of 500 m to 1000 m. The electrode roll can be cut into individual electrode sections, which are installed as electrodes in stored energy sources. The individual electrode sections can have a length of 4 to 5 m, for example, for the round cell format 4695. These are cylindrical cells having a diameter of 46 mm and a height of 95 mm. The first and the second edge of the electrode layer preferably extend along the main axis of the band-shaped electrode layer. In particular, the first and the second edge of the electrode layer can form the long edges of the band-shaped electrode layer.

In a further embodiment of a method according to the disclosure, in method step B), a current conductor tab or a plurality of current conductor tabs can be provided, wherein the current conductor tab or the current conductor tabs are connected to isolated wires, which are not connected to one another, and wherein the wires are movable in relation to one another.

These isolated wires, which are not connected to one another, are movable in relation to one another and enable connecting the first electrode film to the second electrode film particularly easily, without mechanical tensions occurring between the wires and the electrode layer being formed.

Furthermore, it is possible that some of the movable wires connected to a current conductor tab are connected to one another by cross connections. This can also enable a current flow between movable wires connected to one another in the area of the electrode material. The cross connections can comprise, for example, electrical wires which are connected to two movable wires. The cross connections can in particular extend transversely to the extension direction of the wires in the direction of the second edge in the electrode layer being formed.

In method step B), a current conductor tab or a plurality of current conductor tabs can be provided, wherein the movable wires of the current conductor tab or the current conductor tabs comprise wires which are electrically conductively connected to the current conductor tab separately from one another.

Such movable wires are in particular not connected to one another, but rather are only electrically conductively connected to the respective current conductor tab. This enables the wires to be kept movable in relation to one another particularly easily.

In method step A), a first and a second electrode film can be provided, which comprise components selected from a group consisting of: electrically conductive additives, electrically conductive polymers, and at least one dry binding agent. The electrically conductive additives can be selected from a group consisting of: carbon powder, graphite, carbon nanotubes (CNT), carbon nanoparticles, and metal particles. Carbon nanotubes and/or carbon nanoparticles are preferably used as electrically conductive additives. The dry binding agent can be selected from a group consisting of: polytetrafluoroethylene, polypropylene having ultra-high molecular weight, polyethylene, copolymers, polymer mixtures, and the like. These dry binding agents can be fibrillated, in particular can be fibrillated dry without the addition of process solvents. The dry binding agents can in particular be mixed or fibrillated with high shear force, for example, by way of a jet mill, a pin mill, an impact powder mill, or a mixer. The carbon powder can comprise carbon selected from a group consisting of: carbon particles impregnated with metals, graphite particles, and carbon black particles.

The electrically conductive polymers can comprise, for example, poly(3,4-ethylenedioxythiophene): poly(styrene sulfonate) (PEDOT: PSS).

The first and the second electrode film can in particular comprise 80 wt. % to 95 wt. % active material, 0 wt. % to 10 wt. % conductive carbon, for example, carbon/carbon black, carbon nanotubes (CNT), carbon nanoparticles, graphite, and 3 wt. % to 15 wt. % dry binding agent. The weight percentages each relate to the total weight of the electrode films.

The active material in particular comprises electrochemically active material which is capable of absorbing metal ions, in particular lithium ions, and discharging them again. As the active material, the first and the second electrode film can comprise graphite, for example, if the electrode film is to be used as an anode in a lithium-ion battery. Lithium ions can intercalate in the graphite. As the active material for the cathode in a lithium-ion battery as the stored energy source, for example, oxides are used, which comprise lithium, nickel, manganese and cobalt, or phosphates, such as LiCoO2, LiNi0.33Co0.33Mn0.33O2 and/or LiFePO4. Nickel-rich Mn-Co oxides (NMC) are typically used for high-energy cells. Silicon, silicon-carbon compounds, and/or silicon oxides, which can absorb lithium ions, can also be used as the active material.

The electrically conductive self-supporting electrode films can be produced, for example, by way of calendering of mixtures of the respective components.

In a further embodiment of a preferred method according to the disclosure, in method step A), a first and a second electrode film are provided which are self-supporting dry electrode films. The self-supporting dry electrode films can be produced via a solvent-free method, as described above, by way of extrusion methods and calendering. The self-supporting dry electrode films can in particular be free of process solvent residue. In wet-chemical methods for producing electrodes, solvents are normally used, such as water or N-methyl-2-pyrrolidone. Self-supporting dry electrode films are described, for example, in US 2013/157141A1 , to the entirety of the content of which reference is hereby made.

Such a method is particularly well suitable for providing self-supporting electrically conductive electrode films which can be connected to the current conductor tabs using the flexible wires.

In method step B), a current conductor tab or a plurality of current conductor tabs can be provided, which are formed strip-shaped. Strip-shaped current conductor tabs are particularly well suitable to be connected to the poles of a stored energy source.

The current conductor tab or the plurality of current conductor tabs can comprise or be manufactured from a metal or a metal alloy. In particular, the current conductor tabs can comprise metals and alloys selected from a group consisting of: copper, aluminum, copper-aluminum alloy, nickel, stainless steel, titanium, silver, and an aluminum-cadmium alloy.

Depending on the structural form of the stored energy source, the planar current conductor tabs can have a width of 0.5 cm to 1 cm and/or a length of 0.7 cm to 1.3 cm.

The movable wires can comprise or be manufactured from a metal or a metal alloy, wherein the metal or the metal alloy is selected from a group consisting of: copper, aluminum, nickel and copper alloys. Movable wires for the anode preferably comprise or are manufactured from copper. Movable wires for the cathode preferably comprise or are manufactured from aluminum.

The movable wires can have a round or a polygonal cross section. In particular, the wires can have a thickness of 0.1 mm to 1 mm and/or a length of 1 cm to 10 cm.

In particular, in the production of an electrode for a stored energy source, movable electrical wires having different thicknesses and/or different lengths can also be used. Electrical wires having a greater thickness enable a better discharge of the current and the heat toward the current conductor tab, while thinner wires reduce the weight of the electrodes.

In method step B), a current conductor tab or a plurality of current conductor tabs can be provided, wherein each current conductor tab is connected to a plurality of movable wires. In particular, each current conductor tab can be connected to at least two, more preferably at least three movable wires. A current conductor tab can be connected to 2 to 5, preferably 3 to 4 movable electrical wires. This ensures sufficient electrical conductivity from the electrode layer to the current conductor tabs.

The movable wires can in particular be electrically conductively connected to a current conductor tab by way of soldering, adhesive bonding, or welding.

In method step C), the first electrode film can be connected to the second electrode film using a method parameter selected from the group consisting of: application of pressure elevated over normal pressure, and application of temperatures elevated over room temperature. Preferably, in method step C), the first electrode film can be connected to the second electrode film by way of calendering. For this purpose, the first electrode film and the second electrode film can be guided through rotating rollers, wherein both electrode films are connected to one another by way of pressure and an elevated temperature.

In method step C), in particular a linear load of 100 N/mm to 3000 N/mm can be applied. For example, in a 14-roller calender, a linear load of 330 N/mm can be applied.

In method step C), a temperature of 50° C. to 280° C., preferably a temperature of 80° C. to 250° C., can be applied.

In method step C), in particular the first electrode film can be directly connected to the second electrode film. Connecting two electrode films to one another is easier to effectuate than a connection known from the prior art of one electrode layer to a planar current collector film or a current collector mesh. In particular, the first electrode film and the second electrode film can be connected to one another directly in the intermediate spaces which are present between adjacent electrical wires.

In the method according to the disclosure, a current collector layer or current collector mesh therefore does not have to be arranged between the first electrode film and the second electrode film.

The subject matter of the present disclosure is also an electrode for a stored energy source. The electrode comprises:
a self-supporting dry electrode layer, which comprises active material, electrically conductive additives, and a dry binding agent, wherein the dry electrode layer has a first edge and a second edge opposite to the first edge,
at least one current conductor tab, wherein the current conductor tab is electrically conductively connected to metallic and electrically conductive wires, and
wherein the current conductor tab protrudes out of the electrode layer at the first edge, and the electrical wires extend in a random manner in the dry electrode layer in the direction of the second edge.

Such an electrode is particularly easy to produce since no complex pretreatment steps are necessary, such as etching a current collector film, in order to ensure sufficient adhesion of the current collector film to an electrode layer. Furthermore, such an electrode can have enhanced long-term stability, since delamination between the electrical wires and the dry electrode layer does not have to be dealt with.

The electrode according to the disclosure can be both an electrode roll having a length up to 1000 m or an already isolated electrode, which can be installed in an energy storage cell.

Various electrical wires extend random in various ways in the direction of the second edge of the dry electrode layer. This distinguishes an electrode according to the disclosure, for example, from conventional electrodes having a current collector mesh, in which various wires cross over one another in an ordered manner.

In a further embodiment of an electrode of the present disclosure, a plurality of current conductor tabs is present, wherein each current conductor tab is electrically conductively connected to the metallic and electrically conductive wires. The plurality of the current conductor tabs can protrude out of the electrode layer at the first edge. The electrically conductive wires can extend in a random manner in the dry electrode layer in the direction of the second edge of the electrode layer.

Such an embodiment of an electrode according to the disclosure provides a “multi-tab” electrode, in which the current can be discharged via a plurality of current conductor tabs at the pole of the stored energy source.

In particular, in the plurality of current conductor tabs, each current conductor tab can be electrically conductively connected to different electrical wires. These different electrical wires extend in a random manner in the direction of the second edge of the electrode web and can ensure that a good electrical connection is present between the electrode layer and the respective current conductor tabs.

Electrically conductive wires which are electrically conductively connected to adjacent current conductor tabs can cross in the dry electrode layer. This can ensure that good electrical conductivity and a discharge of the current toward the current conductor tabs is possible over the surface of the electrode layer. Furthermore, electrically conductive wires which are electrically conductively connected to adjacent current conductor tabs can contact one another. This can ensure particularly good electrical conductivity of the electrode layer over the entire surface even between adjacent current conductor tabs.

The electrical wires of a current conductor tab can comprise isolated wires which are not connected to one another. Such wires are particularly easily movable in relation to other wires.

The electrical wires can comprise wires which meander in the direction of the second edge of the dry electrode layer. It is possible here that different electrical wires meander in a random manner in different ways in the direction of the second edge of the dry electrode layer. The flexibility and mobility of the electrical wires during method step C), the connection of the first electrode film to the second electrode film, ensures that mechanical tensions do not occur between the wires and the electrode layer being formed.

The metallic wires extending in the dry electrode layer can comprise wires of different lengths and/or different cross sections.

The dry electrode layer can have a density of greater than 0.3 g/cm³ , preferably greater than 0.5 g/cm³ . A dry electrode layer having such a density is particularly well suitable as a self-supporting electrode layer. The dry electrode layer can have, after the connection of the first electrode film to the second electrode film by way of calendering, for example, a density of 1.3 g/cm³ to 1.7 g/cm³ for the anode and of 3 g/cm³ to 3.6 g/cm³ for the cathode.

The current conductor tab or current conductor tabs can be metal strips here, which are electrically conductively connected to the electrical wires. These metal strips or current conductor tab strips can be connected particularly easily, for example, by way of welding, to the pole of a stored energy source.

Each current conductor tab can be electrically conductively connected to a plurality of wires. The plurality of wires can be electrically conductively connected to the current conductor tab separately from one another. In particular, each of the wires of the plurality of wires can only be electrically conductively connected to the current conductor tab, wherein there are no further connections between different wires. This can ensure that the movable wires are particularly easily movable in relation to one another during method step C).

The electrically conductive wires can comprise or be manufactured from metal and/or a metal alloy. The metal can particularly preferably be selected from a group consisting of: copper, aluminum, and nickel. The metal alloy can be selected from a group consisting of: Cu—Al, and Ni—Cu.

The dry electrode layer of the electrode can comprise a dry binding agent selected from a group consisting of: polytetrafluoroethylene, polypropylene having ultra-high molecular weight, polyethylene, copolymers, polymer mixtures, and the like.

The subject matter of the present disclosure is furthermore also a stored energy source, comprising:
an electrode as described above,
a counter electrode,
a separator located between the electrode and counter electrode, and
an electrolyte.

The stored energy source can be, for example, a lithium-ion battery or a solid-state battery.

In a lithium-ion battery, an electrode according to the disclosure can be an anode and/or a cathode. The separator prevents an electrical short circuit between the electrode and the counter electrode and can be a porous, electrically insulating layer made of polyethylene or polypropylene, glass fibers, a polyolefin membrane, or another porous, electrically insulating material. In particular an electrolyte solution can be used as the electrolyte, which contains an aprotic solvent such as ethylene carbonate, propylene carbonate, dimethyl carbonate, diethyl carbonate, or 1,2-dimethoxy ethane and a conductive salt, for example, lithium hexafluorophosphate (LiPF6), lithium tetrafluoroborate (LiBF4), or lithium bis(oxalato)borate, which is dissolved in the aprotic solvent.

An electrode according to the disclosure can also be used in a solid-state battery. In such a stored energy source, lithium can be used as the anode, wherein an electrode according to the disclosure can be used as the cathode. A ceramic permeable to lithium ions, such as lithium orthosilicate, or glass can be used as the solid-state electrolyte.

Such stored energy sources can have greater long-term stability due to the use of electrodes according to the disclosure, since delamination of the electrode layer from a current collector is not a concern. The possibility of the current conduction via multiple current conductor tabs which is present over the surface of the electrode substantially contributes to the reduction of the cell internal resistance. In addition, the homogeneously distributed electrical conduction also promotes the absence of “hotspots”, excess heating at locally limited points. Furthermore, such stored energy sources can be produced more cost-effectively and easily due to the electrode according to the disclosure.

Aspects of the present disclosure will be explained in more detail hereinafter on the basis of figures and exemplary embodiments. In the figures:

### BRIEF DESCRIPTION OF THE DRAWINGS

FIG. 1 shows a schematic cross-sectional view of a method according to the disclosure,

FIG. 2 shows a schematic top view of an electrode according to the disclosure,

FIGS. 3A and 3B show a schematic top view of and a cross section through an embodiment of an electrode according to the disclosure, and

FIGS. 4A and 4B show schematic drawings of a current conductor tab, having metallic wires connected thereto, having movable, flexible wires having cross connections, and a schematic top view of an embodiment of an electrode according to the disclosure having these current conductor tabs.

### DETAILED DESCRIPTION OF THE DRAWINGS

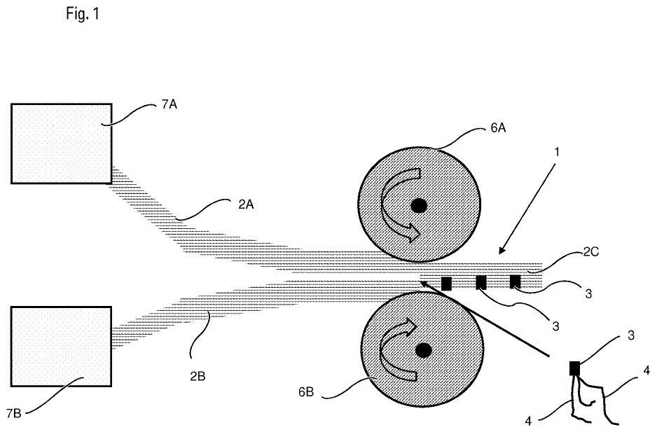

FIG. 1 shows a schematic cross-sectional view of a method according to the disclosure, in which a first self-supporting electrically conductive electrode film 2A is extruded from a first extruder 7A and a second self-supporting electrically conductive electrode film 2B is extruded from a second extruder 7B. Both electrode films 2A, 2B are pressed together by way of calendering rollers 6A, 6B under pressure and at elevated temperature, wherein current conductor tabs 3, which are connected to movable electrical wires 4, are positioned between the two electrode films. The electrode 1 forms here having the self-supporting electrode layer 2C, from which the current conductor tabs 3 protrude. For example, a top view of a current conductor tab 3 having the electrically conductive wires 4 is shown in the bottom right corner of FIG. 1.

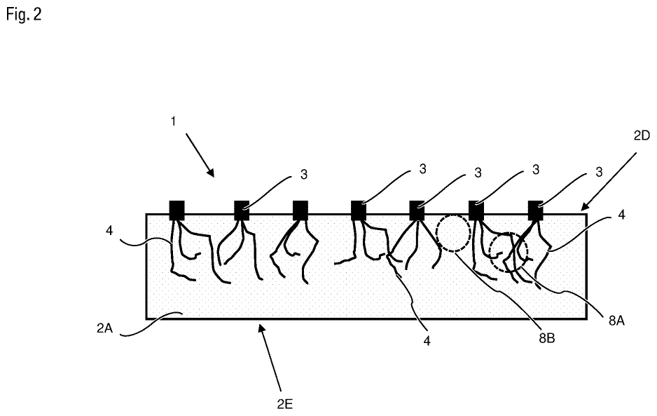

FIG. 2 shows a schematic top view of an embodiment of an electrode 1 according to the disclosure, wherein only the first electrode film 2A is shown for reasons of clarity, but not the second electrode film 2B located above it. This electrode according to the disclosure is already produced by isolation from an electrode roll and can be installed as an individual electrode in a stored energy source. This second electrode film 2B may cover the electrically conductive wires 4 extending through the electrode layer, which are visible in FIG. 2. Each current conductor tab 3 is connected here to a plurality of metallic wires 4, which extend in a random manner in the direction of the second edge 2E of the electrode layer. Each electrically conductive wire 4 meanders in different ways in the direction of the second edge 2E of the electode layer. These electrically conductive wires can be positioned particularly easily between the two conductive electrode films, without there being the risk that mechanical tensions will occur. The current conductor tabs 3 protrude out of the first edge 2D of the electrode film. Electrically conductive wires 4 of adjacent current conductor tabs 3 can either cross or contact one another, as shown in the region 8A shown by dashed lines. Furthermore, an intermediate area 8B shown by dashed lines can form between the electrical wires 4 of two adjacent current conductor tabs 3, in which no wires are present.

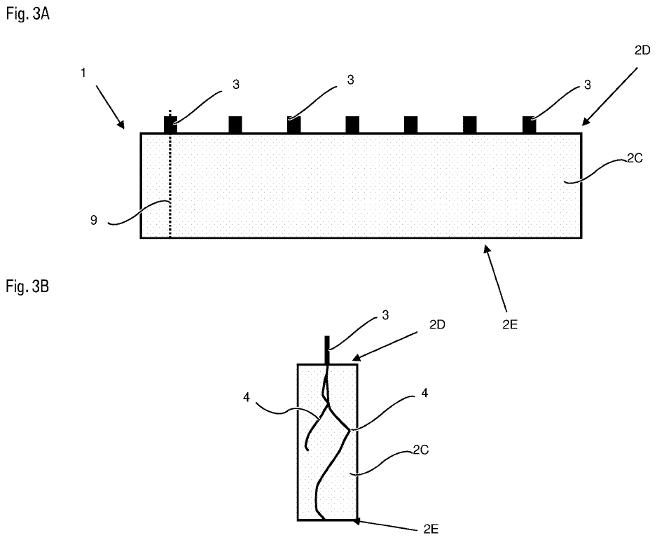

FIG. 3A shows a top view of an embodiment of an electrode 1 according to the disclosure having the self-supporting electrode layer 2C and the current conductor tabs 3 protruding out of the electrode layer. FIG. 3B shows a cross section through the electrode 1 according to the disclosure from FIG. 3A along the dashed line designated by 9. FIG. 3B shows how the electrically conductive wires 4 extend from the current conductor tab 3 protruding at the first edge 2D through the self-supporting electrode layer 2C in the direction of the second edge 2E of the electrode layer.

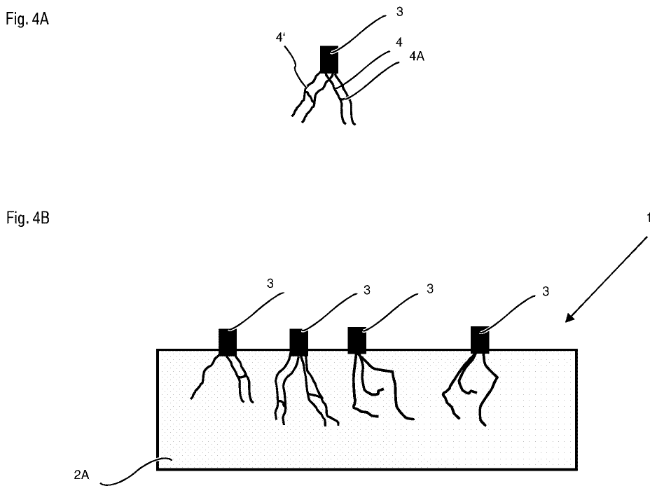

FIG. 4A schematically shows a top view of a current conductor tab 3, which is connected to two different groups 4, 4′ of electrically conductive wires. The groups 4, 4′ of electrically conductive wires each consist of two electrically conductive wires which are electrically conductively connected to one another by a cross connection 4A. Such electrically conductive wires can ensure a good electrical conductivity between adjacent electrical wires. The various groups 4, 4′ of electrically conductive wires are movable in relation to one another. FIG. 4B shows a schematic top view of an embodiment of an electrode 1 according to the disclosure which has current conductor tabs 3, as shown in FIG. 4A. For reasons of clarity, only the first electrode film 2A is shown, so that the course of the electrical wires 4 within the electrode layer is visible. In addition, current conductor tabs having electrical wires, as shown in FIG. 1 and FIG. 2, can also be seen.

The invention is not restricted by the description with reference to the exemplary embodiments. Rather, the invention comprises every novel feature and every combination of features, which includes in particular every combination of features in the claims, even if this feature or this combination is not itself explicitly specified in the claims or exemplary embodiments.

1-14. (canceled)

15. A method for producing an electrode for a stored energy source, the method comprising:
providing a first electrode film and a second electrode film, the first and second electrode films being self-supporting and electrically conductive;
providing at least one current conductor tab electrically connected to movable wires;
arranging the movable wires of the current conductor tab between the first and second electrode films; and
connecting the first electrode film to the second electrode film to form a self-supporting electrode layer,
wherein the current conductor tab protrudes out of the electrode layer and the movable wires extend within the electrode layer.

16. The method for producing an electrode according to claim 15, wherein a plurality of the current conductor tabs are provided, each current conductor tab being connected to movable wires, and
wherein the movable wires of the plurality of current conductor tabs are arranged between the first and second electrode films and wherein the plurality of the current conductor tabs protrude out of the electrode layer.

17. The method for producing an electrode claim 15, wherein the electrode layer has a first edge and a second edge opposite to the first edge, and
wherein the at least one current conductor tab protrudes out of the electrode layer at the first edge, and wherein the movable wires extend in a direction of the second edge within the electrode layer.

18. The method for producing an electrode according to claim 15, wherein the moveable wires comprise isolated wires which are not connected to one another.

19. The method for producing an electrode according to claim 15, wherein the moveable wires of adjacent current conductor tabs comprise wires which contact one another.

20. The method for producing an electrode according to claim 15, wherein the first and second electrode films are self-supporting dry electrode films free of process solvent residue.

21. The method for producing an electrode according to claim 15, wherein the first electrode film is directly connected to the second electrode film, there being no current collector film or mesh arranged between the first electrode film and the second electrode film.

22. An electrode for a stored energy source, comprising:
a self-supporting dry electrode layer comprising active material, electrically conductive additives, and a dry binding agent, wherein the dry electrode layer has a first edge and a second edge opposite to the first edge; and
at least one current conductor tab electrically connected to metallic and electrically conductive wires,
wherein the current conductor tab protrudes out of the electrode layer at the first edge, and
wherein the electrically conductive wires extend in a random manner within the dry electrode layer in a direction of the second edge.

23. The electrode according to claim 22, wherein a plurality of the current conductor tabs are present, each current conductor tab being electrically connected to electrically conductive wires, and
wherein the plurality of the current conductor tabs protrude out of the electrode layer at the first edge and the electrically conductive wires extend in a random manner in the dry electrode layer in a direction of the second edge.

24. The electrode according to claim 23, wherein the electrically conductive wires of adjacent current conductor tabs comprise wires which contact one another in the dry electrode layer.

25. The electrode according to claim 22, wherein the electrically conductive wires of a respective current conductor tab comprise isolated wires which are not connected to one another.

26. The electrode according to claim 22, wherein the metallic wires comprise wires meandering in a direction of the second edge of the dry electrode layer.

27. The electrode according to claim 22, wherein the metallic and electrically conductive wires comprise a metal and/or a metal alloy selected from the group consisting of copper, aluminum, nickel, Cu—Al, and Ni—Cu.

28. The electrode according to claim 22, wherein the dry electrode layer comprises a dry binding agent selected from a group consisting of polytetrafluoroethylene, polyethylene, and polypropylene.

29. A stored energy source, comprising:
the electrode according to claim 22;
a counter electrode;
a separator located between the electrode and counter electrode; and
an electrolyte.
